(19) United States
(12) Patent Application Publication
(10) Pub. No.: US 2026/0199785 A1
(43) Pub. Date: Jul. 16, 2026

(54) VIRTUAL OBJECT CONTROL

(71) Applicant: Tencent Technology (Shenzhen) Company Limited, Shenzhen (CN)

(72) Inventor: Ziyi WANG, Shenzhen (CN)

(73) Assignee: Tencent Technology (Shenzhen) Company Limited, Shenzhen (CN)

(21) Appl. No.: 19/561,473

(22) Filed: Mar. 9, 2026

Related U.S. Application Data
(63) Continuation of application No. PCT/CN2024/138195, filed on Dec. 10, 2024.

(30) Foreign Application Priority Data
Jan. 24, 2024 (CN) 202410104434.X

(51) Int. Cl. A63F 13/56; A63F 13/52; A63F 13/533; A63F 13/573; A63F 13/822; A63F 13/837

(52) U.S. Cl. CPC A63F 13/56; A63F 13/52; A63F 13/533; A63F 13/573; A63F 13/822; A63F 13/837; A63F 2300/8082

(57) ABSTRACT

In a virtual object control method, a virtual object in a virtual scene and a game control interface that includes a pre-jump-throw control element in a jump-throw control state are output for display. The virtual object has a virtual throwable item. Based on the trigger operation performed on the pre-jump-throw control element in the jump-throw control state, a jump-throw control element is output for display in the game control interface. Based on the trigger operation performed on the jump-throw control element, the virtual object is controlled to be in a pre-throw state. Based on at least one of the jump-throw control element or a preset control element in the game control interface, the virtual object is controlled to execute a jump-throw operation. The jump-throw operation includes the virtual object in the pre-throw state throwing the virtual throwable item.

### RELATED APPLICATIONS

The present application is a continuation of International Application No. PCT/CN2024/138195, filed on December 10, 2024, which claims priority to Chinese Patent Application No. 202410104434.X, filed on January 24, 2024. The entire disclosures of the prior applications are hereby incorporated by reference.

### FIELD OF THE TECHNOLOGY

This application relates to the field of computer technologies, including a virtual object control method.

### BACKGROUND OF THE DISCLOSURE

With the continuous development of computer technologies, the number of game players is increasing. By setting a control mode of a virtual object in a game, a player can use different numbers of controls to control the virtual object to execute corresponding operations in a current control mode.

For example, in a first-person shooting (FPS) game, a player can control a virtual object to interact with other virtual objects or a virtual environment by using a virtual throwable item. In the process of throwing the virtual throwable item, in order to throw the virtual throwable item to a relatively distant location, it is necessary to control the virtual object to perform a jump-throw operation. For example, a player simultaneously operates a sprint control, a jump control, and a throw control to complete the jump-throw operation. However, the implementation of this jump-throw operation is complicated, thereby resulting in low human-computer interaction efficiency of the jump-throw operation.

### SUMMARY

Aspects of this disclosure provide a virtual object control method, a virtual object control apparatus, and a non-transitory computer-readable storage medium, which can improve the human-computer interaction efficiency of a jump-throw operation. Examples of technical solutions of this disclosure may be implemented as follows:

An aspect of this disclosure provides a virtual object control method. In the method, a virtual object in a virtual scene and a game control interface that includes a pre-jump-throw control element in a jump-throw control state are output for display. The virtual object has a virtual throwable item. A trigger operation is performed on the pre-jump-throw control element is determined. Based on the trigger operation performed on the pre-jump-throw control element in the jump-throw control state, a jump-throw control element is output for display in the game control interface. A trigger operation performed on the jump-throw control element is determined. Based on the trigger operation performed on the jump-throw control element, the virtual object is controlled to be in a pre-throw state. Based on at least one of the jump-throw control element or a preset control element in the game control interface, the virtual object is controlled to execute a jump-throw operation. The jump-throw operation includes the virtual object in the pre-throw state throwing the virtual throwable item.

An aspect of this disclosure provides a virtual object control apparatus. The apparatus includes processing circuitry configured to output for display a virtual object in a virtual scene and a game control interface that includes a pre-jump-throw control element in a jump-throw control state. The virtual object has a virtual throwable item. The processing circuitry is configured to determine a trigger operation is performed on the pre-jump-throw control element. Based on the trigger operation performed on the pre-jump-throw control element in the jump-throw control state, the processing circuitry is configured to output for display a jump-throw control element in the game control interface. The processing circuitry is configured to determine a trigger operation is performed on the jump-throw control element. Based on the trigger operation performed on the jump-throw control element, the processing circuitry is configured to control the virtual object to be in a pre-throw state. Based on at least one of the jump-throw control element or a preset control element in the game control interface, the processing circuitry is configured to control the virtual object to execute a jump-throw operation. The jump-throw operation includes the virtual object in the pre-throw state throwing the virtual throwable item.

An aspect of this disclosure provides a virtual object control method, the method being executed by a terminal device, and including: displaying a first game interface, the first game interface including a virtual object and a pre-jump-throw control in a jump-throw control state, and the virtual object possessing a virtual throwable item; displaying a jump-throw control in the first game interface in response to a trigger operation of the pre-jump-throw control in a jump-throw control state; controlling, in response to a trigger operation of the jump-throw control, the virtual object to be in a pre-throw state; and controlling, based on at least one of the jump-throw control or a preset control, the virtual object to execute a jump-throw operation, the jump-throw operation being that the virtual object in the pre-throw state throws the virtual throwable item, and the preset control being located in the first game interface.

An aspect of this disclosure provides a virtual object control apparatus, the apparatus including: a first display module, configured to display a first game interface, the first game interface including a virtual object and a pre-jump-throw control in a jump-throw control state, and the virtual object possessing a virtual throwable item; a second display module, configured to display a jump-throw control in the first game interface in response to a trigger operation of the pre-jump-throw control in a jump-throw control state; a first control module, configured to control, in response to a trigger operation of the jump-throw control, the virtual object to be in a pre-throw state; and a second control module, configured to control, based on at least one of the jump-throw control or a preset control, the virtual object to execute a jump-throw operation, the jump-throw operation being that the virtual object in the pre-throw state throws the virtual throwable item, and the preset control being located in the first game interface.

An aspect of this disclosure provides an electronic device, the electronic device including a processor and a memory, the memory having at least one program code stored therein, and the at least one program code being loaded and executed by the processor to enable the computer device to implement any one of the foregoing the virtual object control methods.

An aspect of this disclosure provides a non-transitory computer-readable storage medium storing instructions which, when executed by a processor, cause the processor to implement the foregoing the virtual object control methods.

An aspect of this disclosure a computer program or a computer program product is further provided, the computer program or the computer program product having at least one computer instruction stored therein, and the at least one computer instruction being loaded and executed by a processor to enable a computer to implement any one of the foregoing the virtual object control methods.

The technical solutions provided in the aspects of this disclosure at least bring the following beneficial effects:

In this disclosure, a jump-throw control is displayed in a first game interface by a trigger operation of a pre-jump-throw control; a virtual object is controlled using one control (a jump-throw control or a preset control) or two controls (the jump-throw control and the preset control) in the first game interface to throw a virtual item, that is, the virtual object is controlled to execute a jump-throw operation, such that the distance of the virtual throwable item thrown by the virtual object in a virtual environment is increased, thereby lowering the difficulty in implementing the jump-throw operation. For example, after a player taps the pre-jump-throw control with one finger to display the jump-throw control, the jump-throw control is pressed still with this finger until cancel to control the virtual object to execute the jump-throw operation. For another example, after a player taps the pre-jump-throw control with one finger to display the jump-throw control, the jump-throw control is pressed still with this finger and taps the preset control with another finger to control the virtual object to execute the jump-throw operation with two fingers. It can be seen that the jump-throw operation provided in this disclosure is simple and easy, such that a player can successfully implement the jump-throw operation without multiple attempts, thereby greatly reducing the error rate of the operation, and effectively improving the human-computer interaction efficiency, such that more players can use the jump-throw operation during a game, thereby improving the diversity and competitiveness of game operations to some extent, and thus improving game experience of the players.

### BRIEF DESCRIPTION OF THE DRAWINGS

FIG. 1 is a schematic diagram of an implementation environment of a virtual object control method according to an aspect of this disclosure.

FIG. 2 is a flowchart of a virtual object control method according to an aspect of this disclosure.

FIG. 3 is a schematic diagram of a second game interface according to an aspect of this disclosure.

FIG. 4 is a schematic diagram of a first game interface according to an aspect of this disclosure.

FIG. 5 is a schematic diagram of displaying a jump-throw control according to an aspect of this disclosure.

FIG. 6 is another schematic diagram of displaying a jump-throw control according to an aspect of this disclosure.

FIG. 7 is another schematic diagram of displaying a jump-throw control according to an aspect of this disclosure.

FIG. 8 is another schematic diagram of displaying a jump-throw control according to an aspect of this disclosure.

FIG. 9 is a schematic diagram of sprint and jump of a virtual object according to an aspect of this disclosure.

FIG. 10 is a schematic diagram of a first predicted trajectory and a second predicted trajectory according to an aspect of this disclosure.

FIG. 11 is a flowchart of a virtual object control method according to an aspect of this disclosure.

FIG. 12 is a schematic structural diagram of a virtual object control apparatus according to an aspect of this disclosure.

FIG. 13 is a schematic structural diagram of a terminal device according to an aspect of this disclosure.

FIG. 14 is a schematic structural diagram of a server according to an aspect of this disclosure.

### DETAILED DESCRIPTION

Before the technical solutions of this disclosure are introduced, abbreviations and key terms involved in the aspects of this disclosure are defined. Further, the descriptions of the terms are provided as examples and are not intended to limit the scope of the disclosure.

Virtual environment: referring to an environment provided when an application program runs on a terminal device. The virtual environment refers to an environment created for virtual objects to carry out activities. The virtual environment may be a two-dimensional virtual environment, a 2.5-dimensional virtual environment, a three-dimensional virtual environment, or the like. The virtual environment may be a simulation environment of the real world, a semi-simulated environment of the real world, or a fictional environment. For example, the virtual environment involved in the aspects of this disclosure is a three-dimensional virtual environment.

Virtual object: referring to a movable object in a virtual environment. The movable object may be a virtual character, a virtual animal, a cartoon character, or the like. A player may manipulate virtual objects by using a peripheral component or by tapping a touch display screen. Each virtual object has its own shape and size in the virtual environment, and occupies a portion of space in the virtual environment. For example, when the virtual environment is a three-dimensional virtual environment, the virtual object is a three-dimensional model created based on an animation skeletal technology.

Virtual throwable item: referring to a virtual item that requires being thrown by a virtual object to be triggered. The virtual throwable item includes a virtual bomb, a virtual gas bomb, a virtual signal flare, a virtual smoke bomb, and the like. The virtual throwable item may have a relatively wide range of impact in the virtual environment. For example, the virtual object throws the virtual smoke bomb into the virtual environment, and virtual smoke rapidly diffuses in the virtual environment. In addition, the virtual throwable item may also have large impact on the virtual object itself and other virtual objects. For example, throwing the virtual bomb by the virtual object may damage multiple virtual objects within the area of effect of the virtual bomb.

Jump-throw operation: referring to that a player controls a virtual object to throw a virtual throwable item in the sprint-jump process, or referred to as a jump and throw operation. Through the jump-throw operation, the virtual object may throw the virtual throwable item to a more distant location to implement interaction between the virtual object and other virtual objects or interaction with the virtual environment, for example, killing other virtual objects at a more distant location.

In related art, most players trigger a control by a two-finger operation, and two controls can be simultaneously controlled by the two-finger operation. For example, operations are performed on a screen of a terminal device using thumbs of left and right hands, and the two controls can be tapped simultaneously. There will be a few advanced players who can perform a three-finger or four-finger operation, such that more controls can be controlled simultaneously, and the virtual object can be controlled to implement more complicated operations, for example, the jump-throw operation.

Using an example in which a player requires to trigger three controls simultaneously to control a virtual object to perform a jump-throw operation, it is necessary to trigger a sprint control, a jump control, and a throw control simultaneously for the jump-throw operation, such that the implementation is complicated, and the costs of learning the operation by the player and the error rate of the operation are greatly increased, thereby resulting in low human-computer interaction efficiency of the operation. Moreover, due to the operation complexity of the jump-throw operation, most players rarely use this operation in a game. When the jump-throw operation is implemented with three fingers, other game operations are relatively difficult to implement, for example, a marking operation in the virtual environment. Therefore, the players rarely use the jump-throw operation during a game, thereby resulting that other virtual objects at a relatively long distance cannot be killed, and thus reducing the competitiveness and game experience of the game.

In view of this, an aspect of this disclosure provides a virtual object control method, which can lower the difficulty in implementing a jump-throw operation, such that more players may conveniently and quickly use the jump-throw operation during a game, thereby improving the human-computer interaction efficiency of the jump-throw operation, and improving diversity and competitiveness of game operations to some extent, and thus improving game experience of the players.

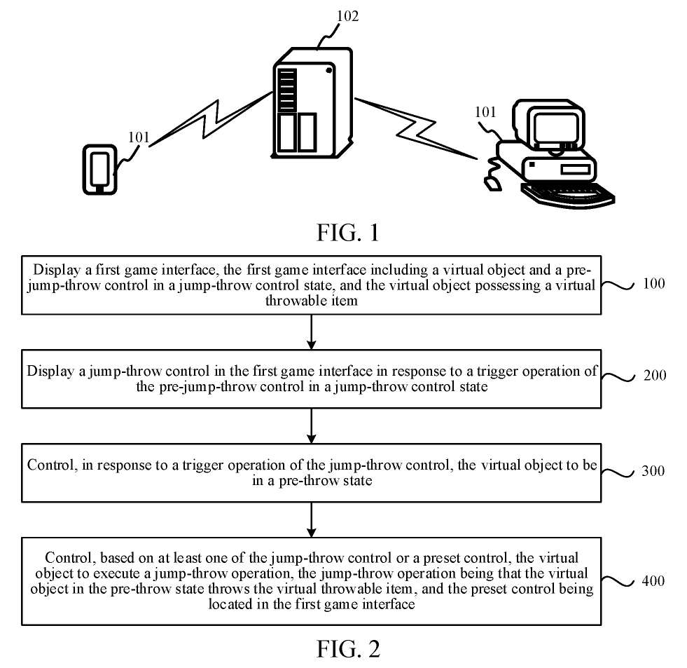

FIG. 1 is a schematic diagram of an implementation environment of a virtual object control method according to an aspect of this disclosure. As shown in FIG. 1, the implementation environment includes: a terminal device 101 and a server 102. A client that can provide a virtual environment is installed and run in the terminal device 101, and the terminal device 101 is configured to execute the virtual object control method according to an aspect of this disclosure.

For example, the client may be a game client, and the game client that provides the virtual environment in the terminal device 101 includes, but is not limited to, a first-person shooting (FPS) game, a third-person shooting (TPS) game, an open-world game, a multiplayer online battle arena (MOBA) game, a multiplayer shooting survival game, a massive multiplayer online role-playing game (MMO), an action role playing game (ARPG), a virtual reality (VR) client, an augmented reality (AR) client, a three-dimensional map program, a map simulation program, a social client, an interactive entertainment client, etc.

For example, the terminal device 101 displays a virtual object and a virtual environment in which the virtual object is located. A user controls, by the terminal device 101, the virtual object in the virtual environment to carry out activities. The activities include, but are not limited to, at least one of the following: adjusting body postures, crawling, walking, running, riding, jumping, driving, virtual shooting, using virtual throwable items, attacking other virtual objects, being attacked by other virtual objects, and sustaining virtual damage (such as poison gas zones and objects falling from high altitudes) in the virtual environment.

The server 102 is configured to provide a backend service for the game client that can provide the virtual environment and is installed for the terminal device 101. In a possible implementation, the server 102 takes on primary computing work, and the terminal device 101 takes on secondary computing work. Alternatively, the server 102 takes on the secondary computing work, and the terminal 101 takes on the primary computing work. Alternatively, collaborative computing is performed between the server 102 and the terminal device 101 by using a distributed computing architecture.

In one aspect, the terminal device 101 may be any electronic device product that perform human-computer interaction with a user in one or more manners such as a keyboard, a touchpad, a remote controller, voice interaction, or a handwriting device. For example, the terminal device 101 may be a smartphone, a tablet computer, a notebook computer, a desktop computer, a smart speaker, a smart watch, a personal computer (PC), a cell phone, a personal digital assistant (PDA), a wearable device, a Pocket PC (PPC), a smart in-vehicle infotainment system, a smart television, and the like.

The terminal device 101 may refer to one of a plurality of terminal devices. In this aspect, the terminal device 101 is merely used as an example for description. A person skilled in the art may know that there may be more or fewer terminal devices 101. For example, there may be only one terminal device 101, or there are dozens or hundreds of terminal device 101, or more. The number and device type of the terminal device 101 are not limited in this aspect of this disclosure.

The server 102 may be one server, or a server cluster formed by multiple servers, or any one of a cloud computing center or a virtualization center, which will not be limited in this aspect of this disclosure. The server 102 and the terminal device 101 can be directly or indirectly connected via wired or wireless communication. The server 102 has a data receiving function, a data processing function, and a data sending function. The server 102 may also have other functions, which will not be limited in this aspect of this disclosure.

It is noted that the terminal device 101 and the server 102 are only examples, and other configurations of terminal devices or servers that are applicable to this disclosure are also to be included in the scope of this disclosure, and are included herein by reference.

An aspect of this disclosure provides a virtual object control method. The method can be applied to the implementation environment shown in FIG. 1. For example, the method is executed by the terminal device 101 in FIG. 1, or the method is implemented through interaction between the terminal device 101 and the server 102. Using an example in which the terminal device 101 executes the method, as shown in FIG. 2, the method includes the following operation 100 to operation 400.

In operation 100, a first game interface is displayed, the first game interface including a virtual object and a pre-jump-throw control in a jump-throw control state, and the virtual object possessing a virtual throwable item. For example, a virtual object in a virtual scene and a game control interface that includes a pre-jump-throw control element in a jump-throw control state are output for display. The virtual object has a virtual throwable item.

In an aspect of this disclosure, a game client that can provide a virtual environment is installed and run in a terminal device. The game client may be a client of any game, which will not be limited in this aspect of this disclosure. For example, an FPS game client is used as an example for description in this disclosure. In response to that the FPS game client receives a start instruction, the terminal device displays a game preloading interface of an application program. The game preloading interface may include a virtual object selection interface, a player team formation interface, a map selection interface, a current game loading interface, and the like. In addition, this disclosure involves multiple types of controls. These controls are displayed in the first game interface by the terminal device based on a game configuration file. The game configuration file is, for example, included in an installation package of the game client.

In an aspect of this disclosure, after the FPS game starts, the first game interface can be displayed. The first game interface includes a virtual object located in a virtual environment, and the virtual object possesses a virtual throwable item.

For example, the virtual environment is an environment provided by an application program of the terminal device. In the virtual environment, a plurality of virtual objects can be displayed. Different virtual objects can be controlled by different players. In addition to displaying the virtual objects, the virtual environment may further display virtual elements. The virtual elements may include mountains, flats, rivers, lakes, oceans, deserts, swamps, flowing sand, the sky, plants, buildings, and the like. The description of the virtual environment is an example in this disclosure, which will not be limited in this disclosure.

In an aspect of this disclosure, the first game interface may further include a plurality of controls. A player controls, by the controls, a virtual object to interact with other virtual objects or a virtual environment, for example, controls the virtual object to crawl, walk, run, jump, drive a virtual vehicle, virtually shoot, or use a virtual throwable item. For example, in the process that the player controls the virtual object to move in the virtual environment, the virtual object can be further controlled to pick up the virtual throwable item in the virtual environment, or control the virtual object to take virtual throwable items from other virtual objects. The description of the manner of acquiring the virtual throwable item is an example in this disclosure, which will not be limited in this disclosure.

In an aspect of this disclosure, the controls in the first game interface may further include a pre-jump-throw control in a jump-throw control state. The pre-jump-throw control is configured to trigger the displaying of the jump-throw control, and the jump-throw control is configured to control a virtual object to execute a jump-throw operation. The pre-jump-throw control may include, but is not limited to, at least one of a joystick control, a throw control, or a jump control. In this disclosure, the pre-jump-throw control being is in a jump-throw control state refers to that after a trigger operation is implemented on the pre-jump-throw control, the first game interface is in a state in which the jump-throw operation can be executed, or when the pre-jump-throw control is in the jump-throw control state, preparations have been made for executing the jump-throw operation.

In a possible implementation, before the first game interface is displayed, the first game interface can also be generated based on a second game interface. The process of generating the first game interface based on the second game interface may include: displaying the second game interface, the second game interface including a virtual object and a pre-jump-throw control in a non-jump-throw control state, and the pre-jump-throw control in a non-jump-throw control state being configured to control the virtual object to execute a specified operation; converting, in response to a use operation of a virtual throwable item, the pre-jump-throw control in a non-jump-throw control state into a pre-jump-throw control in a jump-throw control state; and generating the first game interface based on the virtual object and the pre-jump-throw control in a jump-throw control state. The specified operation is related to a type of the pre-jump-throw control. Using an example in which the pre-jump-throw control includes a joystick control, controlling a virtual object to execute a specified operation is, for example, controlling a location of the virtual object in a virtual environment by the joystick control. Using an example in which the pre-jump-throw control includes a jump control, controlling a virtual object to execute a specified operation is, for example, controlling, by the jump control, the virtual object to jump in a virtual environment. Using an example in which the pre-jump-throw control includes a throw control, controlling a virtual object to execute a specified operation is, for example, controlling, by the throw control, the virtual object to execute an attack operation or throw a virtual throwable item. In addition, generating the first game interface based on the virtual object and the pre-jump-throw control in a jump-throw control state refers to displaying the virtual object and the pre-jump-throw control in the first game interface based on the location of the virtual object in the virtual environment and the jump-throw control state of the pre-jump-throw control. By displaying the second game interface, a technical support is provided for state transition of the pre-jump-throw control and the displaying of the first game interface, allowing a player to know that a use operation can be performed on the virtual throwable item to switch the state of the pre-jump-throw control, thereby improving the game experience of the player.

For example, the second game interface is a game interface before a player controls a virtual object to use a virtual throwable item. The second game interface may include the virtual object, and the virtual object possesses a virtual item in an unused state. When the virtual throwable item is in the unused state, the pre-jump-throw control is in a non-jump-throw control state.

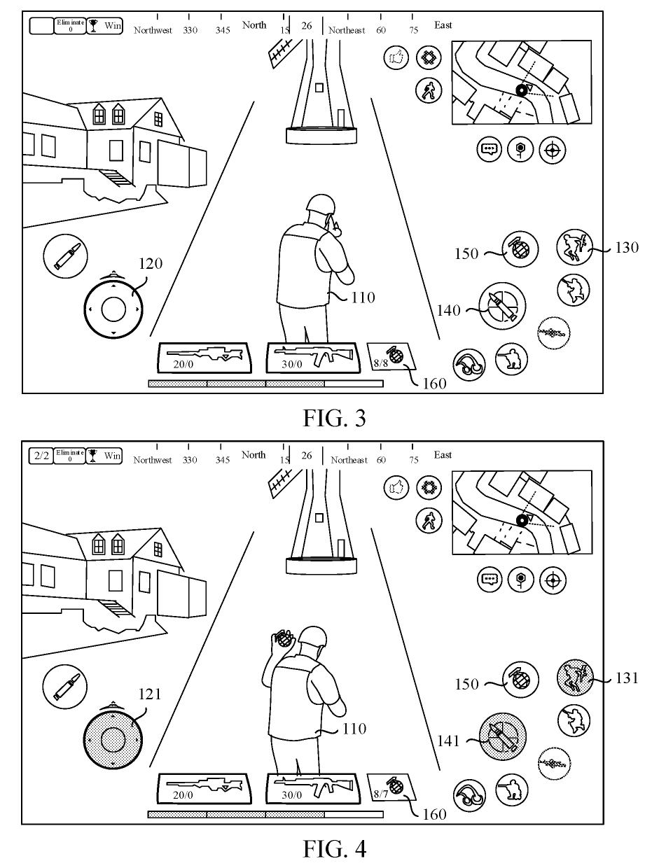

FIG. 3 is a schematic diagram of a second game interface according to an aspect of this disclosure. As shown in FIG. 3, a virtual object 110 in a second game interface is in the state of holding a virtual item (the virtual item is different from a virtual throwable item), and the second game interface includes a pre-jump-throw control in a non-jump-throw control state, where the pre-jump-throw control may include a joystick control 120, a jump control 130, and a throw control 140. The joystick control 120 is configured to control a location of the virtual object in a virtual environment, and a player may control, by controlling the joystick control 120, the virtual object to move forward, backward, left and right in the virtual environment. The jump control 130 is configured to control the virtual object to jump in the virtual environment. For example, the player can cross over a virtual obstacle in the virtual environment by the jump control 130 or use a virtual throwable item 160 in the jump process.

In addition, the virtual object 110 may pick up the virtual throwable item 160 in the virtual environment or the virtual object 110 may take the virtual throwable item 160 from other virtual objects. When the player requires the use of the virtual throwable item 160, the virtual object 110 can be controlled based on a use control 150 of the virtual throwable item to use the virtual throwable item 160. When the virtual throwable item 160 is not used, the throw control 140 is configured to control the virtual object 110 to perform an attack operation. When the virtual throwable item 160 is used, the throw control 140 is configured to control the virtual object 110 to throw the virtual throwable item 160.

In an aspect of this disclosure, in response to a trigger operation of a use control of the virtual throwable item, the pre-jump-throw control in a non-jump-throw control state is converted into a pre-jump-throw control in a jump-throw control state. The pre-jump-throw control in a jump-throw control state may have different display states from the pre-jump-throw control in a non-jump-throw control state. For example, the pre-jump-throw control in a jump-throw control state can be highlighted or shadowed. While controlling a virtual object to execute a corresponding operation, the pre-jump-throw control in a jump-throw control state can be further configured to trigger the displaying of a jump-throw control.

In a possible implementation, in response to a trigger operation of a use control of the virtual throwable item, a virtual object can be converted from the state of holding the virtual item to the use state of the virtual throwable item. For example, the virtual object can hand hold the virtual throwable item. In one aspect, the first game interface may further display a predicted trajectory of the virtual throwable item. The predicted trajectory is a predicted trajectory of the virtual throwable item that corresponds to a motion state of a current virtual object.

For example, after the pre-jump-throw control is in a jump-throw state, the first game interface is generated. An example in which the pre-jump-throw control shadowed is a pre-jump-throw control in a jump-throw state, and the pre-jump-throw control includes a joystick control, a jump control, and a throw control is used as an example for description in this disclosure. FIG. 4 is a schematic diagram of a first game interface according to an aspect of this disclosure. As shown in FIG. 4, after the use control 150 of the virtual throwable item is triggered, the virtual object 110 may hand hold the virtual throwable item 160. In this case, a joystick control 121, a jump control 131, and a throw control 141 are in a jump-throw control state. For example, the joystick control 121, the jump control 131, and the throw control 141 are shadowed in the first game interface.

In an aspect of this disclosure, after a use control of a virtual throwable item is triggered, the virtual throwable item held by a virtual object enters the countdown, and before the countdown ends, the virtual object requires to complete a throw operation of the virtual throwable item. In one aspect, after the use control of the virtual throwable item is triggered, a predicted trajectory of the virtual throwable item can be displayed in a different color as before to remind a player that the virtual throwable item requires to be thrown in time.

The display state of a pre-jump-throw control in a jump-throw control state is different from that of a pre-jump-throw control in a non-jump-throw control state. The different display can be of various manners, as long as the player can distinguish them. The description of the display form of the pre-jump-throw control in a jump-throw control state and the display form of the pre-jump-throw control in a non-jump-throw control state is an example in this disclosure, and the pre-jump-throw controls in the two states can also be displayed in other manners, which will not be limited in this disclosure.

In operation 200, a jump-throw control is displayed in the first game interface in response to a trigger operation of the pre-jump-throw control in a jump-throw control state. For example, based on the trigger operation performed on the pre-jump-throw control element in the jump-throw control state, a jump-throw control element is output for display in the game control interface.

In an aspect of this disclosure, in response to a trigger operation of a control refers to that a terminal device responding to a trigger operation that is performed by the player on the control. According to different situations of the pre-jump-throw control in a jump-throw control state, the manner of displaying the jump-throw control in the first game interface includes, but is not limited to, any one of the following Case 1 to Case 4.

Case 1: The pre-jump-throw control in a jump-throw control state includes a joystick control, the jump-throw control includes a first jump-throw control, and the process of displaying the jump-throw control in the first game interface may include: displaying, in response to a trigger operation of the joystick control in a jump-throw control state in a first direction, a first jump-throw control in the first direction of the joystick control in the first game interface, where the first jump-throw control is configured to control a virtual object to sprint and jump.

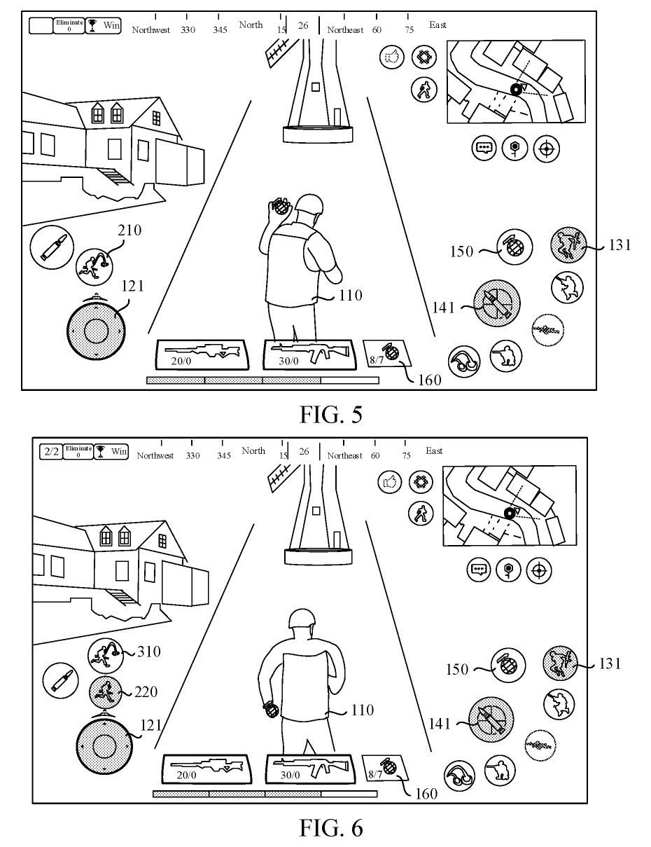

FIG. 5 is a schematic diagram of displaying a jump-throw control according to an aspect of this disclosure. As shown in FIG. 5, using an example in which a first direction of the joystick control 121 in a jump-throw control state is the upper side of the joystick control 121, when a player drags the joystick control 121 upward, a first jump-throw control 210 is displayed at the upper side of the joystick control 121. In the subsequent process, when the first jump-throw control 210 is triggered, the virtual object 110 can be controlled to sprint and jump. It can be seen that the player can drag the joystick control upward with one finger to trigger a terminal device to display the first jump-throw control. In the subsequent process, the player can slide from the joystick control to the first jump-throw control still with this finger to control the virtual object to execute a jump-throw operation, thereby effectively lowering the difficulty in implementing the jump-throw operation.

Case 2: The pre-jump-throw control in a jump-throw control state includes a joystick control, the jump-throw control includes a second jump-throw control, and the process of displaying the jump-throw control in the first game interface may include: displaying, in response to a trigger operation of the joystick control in a jump-throw control state in a first direction, a sprint control in the first direction of the joystick control in the first game interface; and displaying a second jump-throw control in a second direction of the sprint control in the first game interface in response to a trigger operation of the sprint control, where the sprint control is configured to control a virtual object to sprint, and the second jump-throw control is configured to control the virtual object to jump.

The first direction and the second direction may be the same, or may be different. An example in which the first direction and the second direction are the same is used for description in this disclosure.

FIG. 6 is another schematic diagram of displaying a jump-throw control according to an aspect of this disclosure. As shown in FIG. 6, still using the example in which the first direction of the joystick control 121 in a jump-throw control state is the upper side of the joystick control 121, when a player drags the joystick control 121 upward, a sprint control 220 is displayed at the upper side of the joystick control 121. After the sprint control 220 is triggered, a shadow state is displayed. In this case, the virtual object 110 sprints in the virtual environment, and a second jump-throw control 310 is displayed at the upper side of the sprint control 220. In the subsequent process, after the second jump-throw control 310 is triggered, the virtual object 110 can be controlled to jump in the virtual environment. It can be seen that the player can drag the joystick control upward with one finger to trigger a terminal device to display the sprint control, and slides from the joystick control to the sprint control still with this finger to control the virtual object to sprint. In the subsequent process, the player can slide from the sprint control to the second jump-throw control still with this finger to control the virtual object to execute a jump-throw operation, thereby effectively lowering the difficulty in implementing the jump-throw operation.

The second jump-throw control can be displayed only when the player drags the joystick control in a jump-throw control state in the first direction, and when the joystick control in a jump-throw control state is dragged in other directions, the virtual object can be controlled to move in the virtual environment. The player can set the first direction and the second direction based on a game habit of the player in a game setting interface, or the first direction and the second direction are set by a developer. For example, both the first direction and the second direction are set as the upper side of the joystick control. For another example, the first direction is set as the upper left side of the joystick control, and the second direction is set as the upper right side of the joystick control. The setting manners for the first direction and the second direction will not be limited in this disclosure.

Case 3: The pre-jump-throw control in a jump-throw control state includes a throw control, the jump-throw control includes a first jump-throw control, and the process of displaying the jump-throw control in the first game interface may include: acquiring a trigger location of the throw control in response to a trigger operation of the throw control in a jump-throw control state; and displaying the first jump-throw control in a preset region that corresponds to the trigger location in the first game interface, where the first jump-throw control is configured to control a virtual object to sprint and jump.

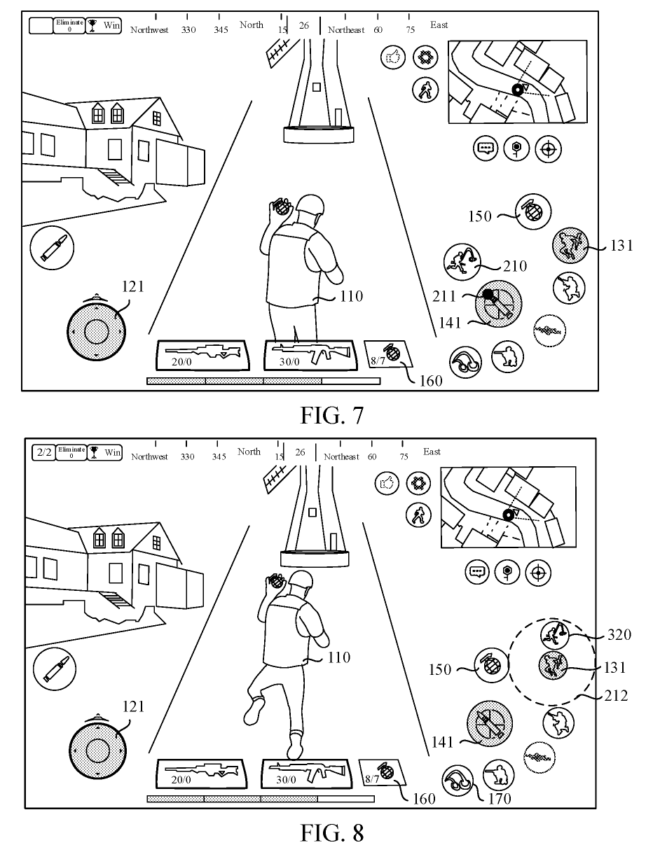

FIG. 7 is another schematic diagram of displaying a jump-throw control according to an aspect of this disclosure. As shown in FIG. 7, after the throw control 141 in a jump-throw control state is triggered, a trigger location 211 of the throw control 141 is determined, where the trigger location may be a location at which the player taps or presses the throw control 141. The first jump-throw control 210 is displayed in a corresponding preset region of the trigger location 211. In the subsequent process, when the first jump-throw control 210 is triggered, the virtual object 110 can be controlled to sprint and jump. It can be seen that the player can tap the throw control with one finger to trigger a terminal device to display the first jump-throw control. In the subsequent process, the player can slide from the throw control to the first jump-throw control still with this finger to control the virtual object to execute a jump-throw operation, thereby effectively lowering the difficulty in implementing the jump-throw operation.

For example, using an example in which the throw control is circular, the throw control is divided into different sectoral regions by taking the circle center of the throw control as a center, and a sectoral region located outside the throw control may be a preset region that corresponds to the trigger location. The preset region that corresponds to the trigger location is determined from the multiple sectoral regions, and in the preset region, the first jump-throw control is displayed at a location that is at a reference distance from the circle center of the throw control. For example, the first jump-throw control can be located on a straight line on which the center of the throw control and the trigger location are located. The reference distance can be set by the player based on a game habit of the player in a game setting interface, or set by a developer. For example, the display size of the first game interface on the terminal device is H×L (H and L are both values greater than 0), and the reference distance may be set as H/10, or the reference distance may be set as L/10. The setting manner for the reference distance here is merely an example and does not constitute a limitation on this disclosure.

In this disclosure, in the process of displaying the first jump-throw control, the trigger location of the throw control is determined, and the first jump-throw control is displayed in the preset region that corresponds to the trigger location, such that operations of the player in a game can be facilitated, and the difficulty in triggering a control in the game is lowered. The player can quickly perform an operation on the first jump-throw control, thereby improving the human-computer interaction efficiency, and thus improving the game experience of the player.

The throw control in this disclosure occupies a relatively large control region in the first game interface. In order to facilitate the operations of the player in the game, the first jump-throw control is displayed in the preset region that corresponds to the trigger location of the throw control. When other controls other than the throw control in a pre-jump-throw control occupy a relatively large control region in the first game interface, a corresponding jump-throw control can also be displayed based on the foregoing method, so as to facilitate game operations of the player. The jump-throw control may include the first jump-throw control or a third jump-throw control, where the third jump-throw control is configured to control a virtual object to sprint.

For example, a control occupying a relatively large control region in the first game interface refers to that the control region is greater than or equal to a control region threshold. For example, the control region occupied by the pre-jump-throw control in the first game interface is compared with the control region threshold. When the control region occupied by the pre-jump-throw control is greater than or equal to the control region threshold, a trigger location of the pre-jump-throw control is determined, and the jump-throw control is displayed in the preset region that corresponds to the trigger location, where the pre-jump-throw control includes, but is not limited to, a throw control and a jump control. The control region threshold can be set by the player based on a game habit of the player in a game setting interface, or set by a developer. For example, the control region threshold is 5% of the display size of the first game interface on the terminal device.

Case 4: The pre-jump-throw control in a jump-throw control state includes a jump control, the jump-throw control includes a third jump-throw control, and the process of displaying the jump-throw control in the first game interface may include: displaying, in response to a trigger operation of a jump control in a jump-throw control state, the third jump-throw control in a region around the jump control in a jump-throw control state, where the third jump-throw control is configured to control a virtual object to sprint, and the jump control is configured to control the virtual object to jump.

FIG. 8 is another schematic diagram of displaying a jump-throw control according to an aspect of this disclosure. As shown in FIG. 8, when the jump control 131 in a jump-throw control state is triggered, the virtual object 110 jumps in a virtual environment, and a third jump-throw control 320 is displayed in a region 212 around the jump control 131 in a jump-throw control state, where the region 212 around the jump control 131 may be a circular region that takes the center of the jump control 131 as a center and a set distance as a radius, such as a dashed region in FIG. 8. The set distance can be set by the player based on a game habit of the player in a game setting interface, or set by a developer. For example, the display size of the first game interface on the terminal device is H × L (H and L are both values greater than 0), and the set distance is H/20, or the set distance is L/20. In addition, the third jump-throw control 320 can be located at any location in the region 212, or may be located at a specified location in the region 212. In one aspect, a location of the third jump-throw control 320 in the region 212 can be set based on a game operation habit of a player. The region around the jump control is not limited to the circular region shown in FIG. 8, and may be a square region, a triangular region, an irregular region, or the like in some scenarios. It can be seen that the player can tap the jump control with one finger to trigger a terminal device to display the third jump-throw control. In the subsequent process, the player can slide from the jump control to the third jump-throw control still with this finger to control the virtual object to execute a jump-throw operation, thereby effectively lowering the difficulty in implementing the jump-throw operation.

An example in which the displaying of the jump-throw control is triggered in the first game interface based on a trigger operation of a joystick control, a throw control, and a jump control in a pre-jump-throw control in a jump-throw control state is used for description in this disclosure, where the pre-jump-throw control in a jump-throw control state may further include other controls, and the displaying of the jump-throw control is triggered based on the other controls, which will not be limited in this disclosure.

In operation 300, the virtual object is controlled, in response to a trigger operation of the jump-throw control, to be in a pre-throw state. For example, based on the trigger operation performed on the jump-throw control element, the virtual object is controlled to be in a pre-throw state.

In an aspect of this disclosure, the jump-throw control can be triggered based on a trigger operation of a player, and the trigger operation of the player may include, but is not limited to, at least one of a tapping operation, a pressing operation, or a sliding operation. For example, the tapping operation is that the player taps the jump-throw control with a finger; the pressing operation is that the player presses the jump-throw control with a finger, and the pressing has a duration, for example, the duration is 2 seconds; and the sliding operation is that a finger of the player slides from other controls to the jump-throw control, where the other controls may include a joystick control, a throw control, and a jump control that are in a jump-throw control state. When the jump-throw control is triggered, the virtual object is controlled to be in a pre-throw state, where the pre-throw state may be a state in which the virtual object holds a virtual throwable item and sprint and jump in a virtual environment.

FIG. 9 is a schematic diagram of sprint and jump of a virtual object according to an aspect of this disclosure. As shown in FIG. 9, in order to better display the sprint-jump process of a virtual object in a virtual environment, the virtual object 110 is represented by a circle, and the virtual object 110 can periodically sprint and jump. In FIG. 9, using an example in which the virtual object 110 sprints and jumps for n cycles, n is a positive integer, and one cycle is from takeoff to touchdown of the virtual object 110. Within each cycle, the virtual object 110 jumps once and moves a distance in a forward direction. Using a first cycle T1 as an example, the virtual object 110 starts to jump from a takeoff point 311, and ends the jump at a touchdown point 313. The distance for which the virtual object jumps once and moves in the forward direction can be set by a player based on a game habit of the player in a game setting interface, or set by a developer. For example, using an example in which a stride length of a virtual object in a virtual environment is 50 cm, the distance for which the virtual object jumps once and moves in a forward direction is 1 m.

In this disclosure, a pre-throw state of the virtual object is triggered by a jump-throw control, and the virtual object in the pre-throw state sprints and jumps in the virtual environment, thereby facilitating the simplification of the subsequent process in which a player controls the virtual object to execute a jump-throw operation, facilitating operations of the player in a game, and improving the human-computer interaction efficiency and game experience of the player.

In operation 400, the virtual object is controlled, based on at least one of the jump-throw control or a preset control, to execute a jump-throw operation, the jump-throw operation being that the virtual object in the pre-throw state throws the virtual throwable item, and the preset control being located in the first game interface. For example, based on at least one of the jump-throw control element or a preset control element in the game control interface, the virtual object is controlled to execute a jump-throw operation. The jump-throw operation includes the virtual object in the pre-throw state throwing the virtual throwable item.

In an aspect of this disclosure, the process of controlling, based on at least one of the jump-throw control or a preset control, the virtual object to execute a jump-throw operation may include: controlling, based on the jump-throw control, the virtual object to execute the jump-throw operation, when a control state of the jump-throw control changes and a control state of the preset control does not change; or, controlling, based on the preset control, the virtual object to execute the jump-throw operation, when both the control state of the jump-throw control and the control state of the preset control change; or, controlling, based on the jump-throw control and the preset control, the virtual object to execute the jump-throw operation, when the control state of the jump-throw control does not change and the control state of the preset control changes. The control state of the jump-throw control refers to whether a trigger operation is performed on the jump-throw control and the state of the performed trigger operation. For example, the control state of the jump-throw control is continuously pressing the jump-throw control. For another example, the control state of the jump-throw control is not tapped. The control state of the preset control is similar to the control state of the jump-throw control, which will not repeated. By detecting whether the control state of the jump-throw control and the control state of the preset control change, a variety of manners of implementing the jump-throw operation are provided, thereby increasing the diversity of the jump-throw operation.

In an aspect of this disclosure, a virtual object is controlled using a control in a first game interface to execute a jump-throw operation, that is, a virtual object in a virtual throw state is controlled to throw a virtual item. For example, the virtual object is controlled by a jump-throw control to execute the jump-throw operation. For example, the control state of the jump-throw control and the control state of the preset control are detected. When it is detected that the control state of the jump-throw control changes and the control state of the preset control does not change, for example, in the process from when the player presses the jump-throw control to when the player cancels pressing the jump-throw control, the preset control is not tapped. In this case, the virtual object throws a virtual throwable item in the sprint-jump state, such that the virtual object completes the jump-throw operation. The player can implement the jump-throw operation of the virtual object by controlling the jump-throw control with one finger, thereby simplifying the manner of implementing the jump-throw operation, and thus allowing the jump-throw operation simple and easy, such that the player can successfully implement the jump-throw operation without multiple attempts, thereby greatly reducing the error rate of the operation, and effectively improving the human-computer interaction efficiency.

In an aspect of this disclosure, a virtual object is controlled using a control in a first game interface to execute a jump-throw operation, that is, a virtual object in a virtual throw state throws a virtual item. For example, the virtual object is controlled by a preset control to execute the jump-throw operation. For example, the control state of the jump-throw control and the control state of the preset control are detected, and when it is detected that the control state of the jump-throw control and the control state of the preset control change, for example, the player presses the jump-throw control to cancels pressing the jump-throw control and the player taps the preset control. In this case, after the preset control is tapped, the virtual object throws a virtual throwable item in the sprint-jump state. The preset control may be any control in the first game interface other than the jump-throw control. For example, when the jump-throw control is a joystick control, the preset control may be a throw control. The preset control is configured to control the virtual object to execute the jump-throw operation. That is, when the preset control is triggered, the virtual object throws the virtual throwable item in the sprint-jump state, such that the virtual object completes the jump-throw operation.

In a possible implementation, when the distance between a jump-throw control and a preset control in a first game interface is relatively small, a jump-throw operation of a virtual object can be implemented only by controlling the preset control with one finger, for example, the preset control is tapped with a finger that presses the jump-throw control, and when the distance between the jump-throw control and the preset control in the first game interface is relatively large, the jump-throw operation of the virtual object can be implemented only by controlling the preset control and the jump-throw control with two fingers, for example, one finger cancels pressing the jump-throw control, and the other finger taps the preset control. For example, the distance between the jump-throw control and the preset control in the first game interface is relatively small, which refers to that the distance is less than a distance threshold, and the distance between the jump-throw control and the preset control in the first game interface is relatively large, which refers to that the distance is greater than or equal to the distance threshold. The distance threshold can be set by the player based on a game habit of the player in a game setting interface, or set by a developer. For example, the distance threshold is 1 cm.

In an aspect of this disclosure, when a virtual object is controlled by two controls in a first game interface to execute a jump-throw operation, for example, the virtual object is controlled by a jump-throw control and a preset control to execute the jump-throw operation, that is, a virtual object in a virtual throw state is controlled to throw a virtual item. For example, the control state of the jump-throw control and the control state of the preset control are detected, and when it is detected that the control state of the jump-throw control does not change and the control state of the preset control changes, for example, the player taps the preset control while continuously pressing the jump-throw control. In this case, the virtual object throws a virtual throwable item in the sprint-jump state. The preset control may be any control in the first game interface other than the jump-throw control. For example, when the jump-throw control is a joystick control, the preset control may be a throw control. The preset control is configured to assist in controlling the virtual object to execute the jump-throw operation. That is, when the jump-throw control is in a pressing state and the preset control is triggered, the virtual object throws the virtual throwable item in the sprint-jump state, such that the virtual object completes the jump-throw operation. The player can implement the jump-throw operation of the virtual object by simultaneously controlling the jump-throw control and the preset control with two fingers.

In this disclosure, a jump-throw control is displayed in a first game interface by a trigger operation of a pre-jump-throw control; a virtual object is controlled using one control (a jump-throw control or a preset control) or two controls (the jump-throw control and the preset control) in the first game interface to execute a jump-throw operation, such that the distance of the virtual throwable item thrown by the virtual object in a virtual environment is increased, thereby lowering the difficulty in implementing the jump-throw operation. For example, after a player taps the pre-jump-throw control with one finger to display the jump-throw control, the jump-throw control is pressed still with this finger to control the virtual object to execute the jump-throw operation. For another example, after a player taps the pre-jump-throw control with one finger to display the jump-throw control, the jump-throw control is pressed still with this finger and taps the preset control with another finger to control the virtual object to execute the jump-throw operation with two fingers. It can be seen that the jump-throw operation provided in this disclosure is simple and easy, such that a player can successfully implement the jump-throw operation without multiple attempts, thereby greatly reducing the error rate of the operation, and effectively improving the human-computer interaction efficiency, such that more players can use the jump-throw operation during a game, thereby improving the diversity and competitiveness of game operations to some extent, and thus improving game experience of the players.

In this aspect of this disclosure, since the player may implement the jump-throw operation with one finger or two fingers, in the process of implementing the jump-throw operation, the player can also implement other operations in a game, thereby reducing the operation difficulty of the game, and increasing the possibility of controlling the virtual object to implement other complicated operations in the game.

In an aspect of this disclosure, before a virtual object executes a jump-throw operation, a motion trajectory of a virtual throwable item in the process of the jump-throw operation is predicted to obtain a predicted trajectory of the virtual throwable item. When the virtual object executes the jump-throw operation, the virtual throwable item moves based on the predicted trajectory.

For example, the process of controlling, based on at least one of the jump-throw control or a preset control, the virtual object to execute a jump-throw operation may include operation 410 to operation 430.

In operation 410, location information and jump-throw parameters are acquired when the control state of the jump-throw control or the preset control changes, the location information including at least one of a location of the virtual object or a location of the virtual throwable item.

In an aspect of this disclosure, the control state of a jump-throw control or a preset control is detected, and when it is detected that the control state of the jump-throw control or the preset control changes, for example, the jump-throw control is converted from a pressing state into a non-pressing state or the preset control is tapped, and location information and jump-throw parameters are acquired, where the location information may include at least one of a location of a virtual object or a location of a virtual throwable item. The location information of the virtual object includes coordinates of the virtual object in a virtual environment, the location of the virtual throwable item includes coordinates of the virtual throwable item in the virtual environment, and the jump-throw parameters are configured for assisting in determining a predicted trajectory of the virtual throwable item. The jump-throw parameters may include, but are not limited to, virtual environment information, a throw function, a reference state of the virtual object, a throw parameter of the virtual throwable item, and the like, where the reference state of the virtual object is the state of the virtual object in the sprint-jump process at a current moment.

In operation 420, a predicted trajectory of the virtual throwable item is displayed, the predicted trajectory being obtained based on the location information and the jump-throw parameters, and the predicted trajectory of the virtual throwable item being a curve from a jump-throw start point of the virtual throwable item to a jump-throw end point of the virtual throwable item.

In an aspect of this disclosure, before a predicted trajectory of a virtual throwable item is displayed, the predicted trajectory of the virtual throwable item is generated. The process of generating the predicted trajectory of the virtual throwable item may include operation 421 and operation 422.

In operation 421, a jump-throw start point of the virtual throwable item is determined based on the location information.

For example, the virtual object may hand hold the virtual throwable item in the sprint-jump state, and a location of the virtual throwable item when the control state of the jump control or the preset control changes is used as the jump-throw start point of the virtual throwable item.

When the location information is a location of a virtual object, the location of the virtual object may include, but not limited to, a location of the center point of the virtual object, a motion posture of the virtual object, and a reference distance between a hand of the virtual object and the center point. A hand location of the virtual object is determined using the motion posture of the virtual object in a virtual environment and the location of the center point of the virtual object, where in the sprint-jump process of the virtual object, the distance between the hand location of the virtual object and the center point of the virtual object is a reference distance, and coordinates of the jump-throw start point of the virtual throwable item are determined by coordinates of the center point of the virtual object. In the sprint-jump process of the virtual object, the reference distance can change with the change of the motion state of the virtual object.

When the location information is the location of the virtual throwable item, coordinates of the location of the virtual throwable item can be directly used as the jump-throw start point of the virtual throwable item.

In operation 422, the predicted trajectory of the virtual throwable item is generated based on the jump-throw start point of the virtual throwable item and the jump-throw parameters.

For example, after the jump-throw start point is determined, a corresponding throw function of the virtual throwable item in the jump-throw process is determined based on the jump-throw parameters, and when any one of the virtual environment in which the virtual object is located, the reference state of the virtual object, or the throw parameters of the virtual throwable item is different, the corresponding throw function of the virtual throwable item in the jump-throw process may be different. After the throw function is determined, the predicted trajectory of the virtual throwable item can be generated based on the jump-throw start point and the throw function. Further, a jump-throw end point of the virtual throwable item is determined by the predicted trajectory of the virtual throwable item. When there are other virtual objects on the predicted trajectory, the jump-throw end point is an interaction point between the virtual throwable item and the other virtual objects; and when there are no other virtual objects on the predicted trajectory, the jump-throw end point is an interaction point between the virtual throwable item and the virtual environment.

In this disclosure, the jump-throw start point of the virtual throwable item is determined using the location information. In the sprint-jump process of the virtual object, the predicted trajectory of the virtual throwable item is generated by the jump-throw start point and the jump-throw parameters, and the virtual throwable item is thrown based on the predicted trajectory, such that the throw distance of the virtual throwable item can be increased to some extent.

In another aspect of this disclosure, when the location information includes a location of a virtual object, the process of generating the predicted trajectory of the virtual throwable item may include operation 423 to operation 426.

In operation 423, a reference state of the virtual object is determined based on the location of the virtual object, the reference state including a jump-throw initial state and a jump-throw intermediate state.

For example, in the sprint-jump state, the virtual object can do periodic sprint-jump motion in a virtual environment. The reference state of the virtual object can be determined using the location of the virtual object when the control state of the jump-throw control or the preset control changes. In conjunction with FIG. 9, the reference state of the virtual object is described as an example. The reference state includes a jump-throw initial state and a jump-throw intermediate state, where the jump-throw initial state may be a state in which the virtual object gets ready to jump when the virtual object is located at the takeoff point 311, and the jump-throw intermediate state may be other states other than the jump-throw initial state in the jump process. For example, the jump-throw intermediate state may be the state of the virtual object located at a location other than the takeoff point 311 within a T1 cycle.

In operation 424: a location of a first throw point is acquired when the virtual object is in the jump-throw initial state, and a jump-throw start point of the virtual throwable item is determined based on the location of the first throw point, the first throw point being the location of a highest point to which the virtual object jumps in a current cycle.

For example, when the control state of the jump-throw control or the preset control changes, the virtual object is in the jump-throw initial state. That is, in conjunction with FIG. 9, when the control state of the jump-throw control or the preset control changes, the virtual object is located at the takeoff point 311. A first throw point 312-1 is a highest point that the virtual object 110 can reach within a T1 jump cycle. Then, the jump-throw start point of the virtual throwable item is determined using the location of the first throw point 312-1, where the determining a jump-throw start point of the virtual throwable item using the location of the first throw point 312-1 is similar to operation 421, which will not be repeated more here.

In operation 425, a location of a second throw point is acquired when the virtual object is in the jump-throw intermediate state, and a jump-throw start point of the virtual throwable item is determined based on the location of the second throw point, the second throw point being the location of a highest point to which the virtual object jumps in a next cycle of the current cycle.

For example, when the control state of the jump-throw control or the preset control changes, the virtual object is in the jump-throw intermediate state. That is, in conjunction with FIG. 9, when the control state of the jump-throw control or the preset control changes, the virtual object is located at a location other than the takeoff point 311. The second throw point 312-2 is a highest point that the virtual object 110 can reach in a next cycle, that is, in a T2 jump cycle. Then, the jump-throw start point of the virtual throwable item is determined using the location of the second throw point 312-2, where the determining a jump-throw start point of the virtual throwable item using the location of the second throw point 312-2 is similar to operation 421, which will not be repeated more here.

In operation 426, the predicted trajectory of the virtual throwable item is generated based on the jump-throw start point of the virtual throwable item and the jump-throw parameters. The process of determining the predicted trajectory in operation 426 is similar to operation 422, which will not be repeated more here.

In this disclosure, the first throw point or the second throw point is determined by the reference state of the virtual object, where the first throw point is the highest point that the virtual object can reach in a current sprint-jump cycle, and the second throw point is the highest point that the virtual object can reach in a next sprint-jump cycle. The jump-throw start point is determined based on the location of the virtual object when the virtual object is located at the highest point, such that the throw distance of the virtual throwable item can be further increased.

Through the above-mentioned manner, the periodic sprint-jump motion of the virtual object is fully considered, and the location of the throw point is obtained based on different reference states of the virtual object during the sprint-jump motion, thereby ensuring that the acquired location of the throw point is accurate, and thus ensuring the accuracy of the predicted trajectory.

In an aspect of this disclosure, in operation 422 and operation 426, in the process of generating the predicted trajectory of the virtual throwable item based on the jump-throw start point of the virtual throwable item and the jump-throw parameters, throw parameters of throwing the virtual throwable item by the virtual object can also be determined based on the jump-throw parameters, and the predicted trajectory of the virtual throwable item is determined in conjunction with the throw parameters.

For example, when the location information includes a location of a virtual object, the process of generating the predicted trajectory of the virtual throwable item based on the jump-throw start point of the virtual throwable item and the jump-throw parameters may include: determining, when the jump-throw parameter includes a first throw parameter, a jump-throw start point of the virtual throwable item based on the location of the virtual object and the first throw parameter, and determining a first predicted trajectory based on the jump-throw start point and first throw parameter of the virtual throwable item; determining, when the jump-throw parameter includes a second throw parameter, a jump-throw start point of the virtual throwable item based on the location of the virtual object and the second throw parameter, and determining a second predicted trajectory based on the jump-throw start point and second throw parameter of the virtual throwable item, in the first throw parameter and the second throw parameter, at least one of a relative location of the virtual throwable item and the virtual object, an angle at which the virtual object throws the virtual throwable item, or an initial speed at which the virtual object throws the virtual throwable item being different.

For example, the throw parameters may include the first throw parameter and the second throw parameter. In the first throw parameter and the second throw parameter, at least one of the relative location of the virtual throwable item and the virtual object, the angle at which the virtual object throws the virtual throwable item, or the initial speed at which the virtual object throws the virtual throwable item is different. For example, in the first throw parameter and the second throw parameter, the relative location of the virtual throwable item and the virtual object, the angle at which the virtual object throws the virtual throwable item, or the initial speed at which the virtual object throws the virtual throwable item are all different. For another example, in the first throw parameter and the second throw parameter, the relative location of the virtual throwable item and the virtual object is the same, and the angle at which the virtual object throws the virtual throwable item or the initial speed at which the virtual object throws the virtual throwable item are different.

When the jump-throw parameters includes the first throw parameter, first relative location information of the virtual throwable item and the virtual object is acquired, where the first relative location information may include a direction of the virtual throwable item relative to the virtual object and a distance of the virtual throwable item relative to the virtual object. The jump-throw start point of the virtual throwable item is determined based on the location of the virtual object and the first relative location information. The first predicted trajectory is obtained using a throw function that corresponds to the first throw parameter and the jump-throw start point of the virtual throwable item.

When the jump-throw parameters includes the second throw parameter, second relative location information of the virtual throwable item and the virtual object is acquired, where the second relative location information may include a direction of the virtual throwable item relative to the virtual object and a distance of the virtual throwable item relative to the virtual object. The jump-throw start point of the virtual throwable item is determined based on the location of the virtual object and the second relative location information. The second predicted trajectory is obtained using a throw function that corresponds to the second throw parameter and the jump-throw start point of the virtual throwable item.

Through the above-mentioned manner, when the predicted trajectory of the virtual throwable item includes two predicted trajectories, a predicted trajectory that requires to be displayed can be quickly determined according to the type of the throw parameters included in the jump-throw parameter, thereby improving the display efficiency of the predicted trajectory.

A throw function curve that corresponds to the first throw parameter is different from a throw function curve that corresponds to the second throw parameter. For example, the throw function is, for example, a physical law-based mathematical model. The jump-throw start point of the virtual throwable item can be substituted into the throw function to obtain a corresponding predicted trajectory.

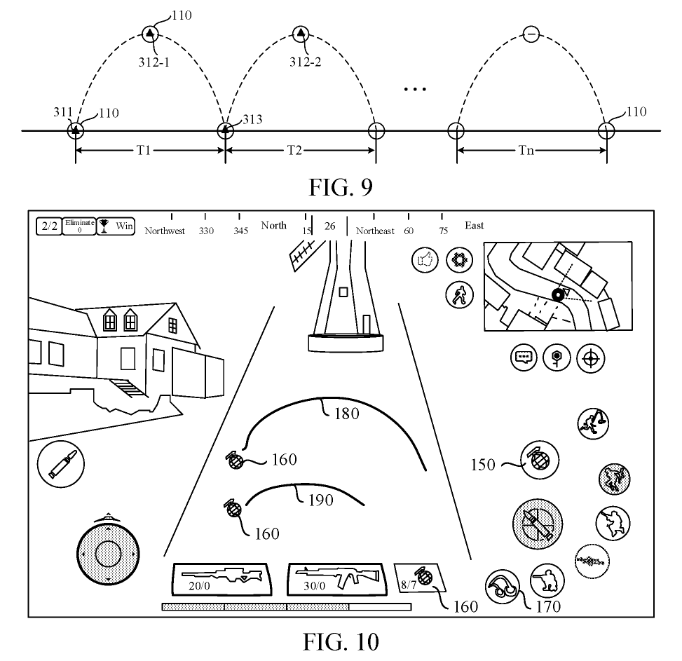

FIG. 10 is a schematic diagram of a first predicted trajectory and a second predicted trajectory according to an aspect of this disclosure. As shown in FIG. 10, the first game interface may further include a throw parameter control 170. A throw parameter of throwing a virtual throwable item 160 by the virtual object can be switched by the throw parameter control 170, where the throw parameter may include a first throw parameter and a second throw parameter. For example, the first throw parameter may correspond to high throw, that is, the virtual object may lift the virtual throwable item 160 to a highest location (not shown in the figure), and throw the virtual throwable item 160 at a first angle and a first initial speed to obtain a first predicted trajectory 180. The second throw parameter may correspond to low throw, that is, the virtual object 110 may place the virtual throwable item 160 at a waist location (not shown in the figure) of the virtual object, and throw the virtual throwable item 160 at a second angle and a second initial speed to obtain a second predicted trajectory 190. At least one of the first angle, the second angle, or the first initial speed and the second initial speed is different. For example, the first angle is greater than the second angle, and the first initial speed is greater than the second initial speed.

In this disclosure, in the process of generating the predicted trajectory, the throw parameters of the virtual throwable item can also be selected to obtain corresponding predicted trajectories under different throw parameters. A player can flexibly select the throw parameters of the virtual throwable item, thereby increasing the diversity of a motion trajectory of the virtual throwable item in the jump-throw process. Moreover, the player can jump to a highest point in the jump-throw process to throw the virtual throwable item using the throw parameter that corresponds to the high throw, such that the farthest throw distance of the virtual throwable item can be realized, thereby increasing the competitiveness of a game and diversity of the game process, and improving the game experience of the player.

The above-mentioned process of generating the predicted trajectory may alternatively be executed by a server. For example, a terminal device acquires location information and jump-throw parameters when the control state of the jump control or the preset control changes, and sends the location information and the jump-throw parameters to the server. The server generates a predicted trajectory of the virtual throwable item based on the location information and the jump-throw parameter, and controls the terminal device to display the predicted trajectory of the virtual throwable item in the first game interface. In this way, computing resources of the terminal device are saved.

In operation 430, the virtual throwable item is thrown based on the predicted trajectory, where the virtual throwable item moves based on the predicted trajectory of the virtual throwable item.

The virtual throwable item moves based on the predicted trajectory of the virtual throwable item, which refers to that the virtual throwable item starts from a jump-throw start point, and moves along the predicted trajectory until reaching a jump-throw end point. For example, after the predicted trajectory of the virtual throwable item is determined, the player can determine, by using the predicted trajectory, whether the jump-throw end point of the virtual throwable item is within a target region, where the target region is a region to which the player requires to throw the virtual throwable item. If the jump-throw end point is located inside the target region, the virtual object is controlled to throw the virtual throwable item; if the jump-throw end point is located outside the target region, the virtual object is controlled to move, or when the throw parameter that corresponds to the high throw is switched until the jump-throw end point is located inside the target region, the virtual object is controlled to throw the virtual throwable item.

In an aspect of this disclosure, after the virtual object throws the virtual throwable item through a jump-throw operation, the virtual object is controlled to restore an initial state, such that the player knows in time that the jump-throw operation has been executed, thereby improving the game experience of the player. The initial state is a state of the virtual object before a use operation of the virtual throwable item in a second game interface. For example, the initial state may be a virtual item holding state of the virtual object. For example, after the virtual object throws the virtual throwable item through the jump-throw operation, the jump-throw control can be hidden or disappeared to avoid the accidental tap by the player.

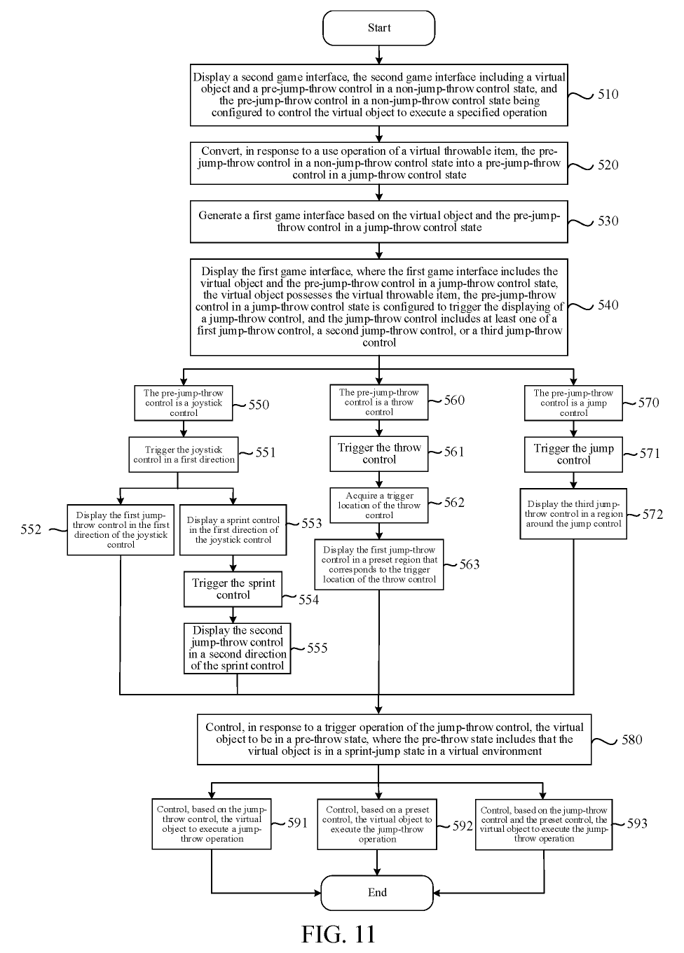

FIG. 11 is a flowchart of a virtual object control method according to an aspect of this disclosure. The method can be executed by the terminal device 101 in the implementation environment shown in FIG. 1, and includes the following contents.

Operation 510: Display a second game interface, the second game interface including a virtual object and a pre-jump-throw control in a non-jump-throw control state, and the pre-jump-throw control in a non-jump-throw control state being configured to control the virtual object to execute a specified operation.

Operation 520: Convert, in response to a use operation of a virtual throwable item, the pre-jump-throw control in a non-jump-throw control state into a pre-jump-throw control in a jump-throw control state.

Operation 530: Generate a first game interface based on the virtual object and the pre-jump-throw control in a jump-throw control state.

Operation 540: Display the first game interface, where the first game interface includes the virtual object and the pre-jump-throw control in a jump-throw control state, the virtual object possesses the virtual throwable item, the pre-jump-throw control in a jump-throw control state is configured to trigger the displaying of a jump-throw control, and the jump-throw control includes at least one of a first jump-throw control, a second jump-throw control, or a third jump-throw control.

In a possible implementation, the process from operation 510 to operation 540 has been described in operation 100 above, which will not be repeated here.

Operation 550: The pre-jump-throw control is a joystick control.

Operation 551: Trigger the joystick control in a first direction.

Operation 552: Display the first jump-throw control in the first direction of the joystick control.

Operation 553: Display a sprint control in the first direction of the joystick control.

Operation 554: Trigger the sprint control.

Operation 555: Display the second jump-throw control in a second direction of the sprint control.

Operation 560: The pre-jump-throw control is a throw control.

Operation 561: Trigger the throw control.

Operation 562: Acquire a trigger location of the throw control.

Operation 563: Display the first jump-throw control in a preset region that corresponds to the trigger location of the throw control.

Operation 570: The pre-jump-throw control is a jump control.

Operation 571: Trigger the jump control.

Operation 572: Display the third jump-throw control in a region around the jump control.

In a possible implementation, the processes from operation 550 to operation 555, operation 560 to operation 563 and operation 570 to operation 572 have already been described in operation 200 above, which will not be repeated here.

Operation 580: Control, in response to a trigger operation of the jump-throw control, the virtual object to be in a pre-throw state, where the pre-throw state includes that the virtual object is in a sprint-jump state in a virtual environment.

In a possible implementation, the process of operation 580 has been described in operation 300 above, which will not be repeated here.

Operation 591: Control, based on the jump-throw control, the virtual object to execute a jump-throw operation.

Operation 592: Control, based on a preset control, the virtual object to execute the jump-throw operation.

Operation 593: Control, based on the jump-throw control and the preset control, the virtual object to execute the jump-throw operation.

In a possible implementation, the process from operation 591 to operation 593 has been described in operation 400, which will not be repeated here.

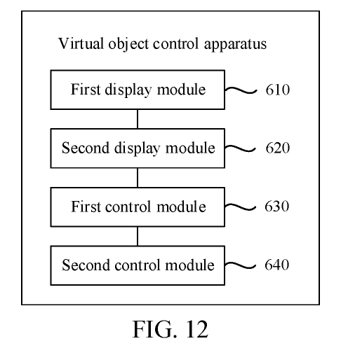

This disclosure further provides a virtual object control apparatus. FIG. 12 is a schematic structural diagram of a virtual object control apparatus according to an aspect of this disclosure. As shown in FIG. 12, the apparatus includes:

a first display module 610, configured to display a first game interface, the first game interface including a virtual object and a pre-jump-throw control in a jump-throw control state, and the virtual object possessing a virtual throwable item;

a second display module 620, configured to display a jump-throw control in the first game interface in response to a trigger operation of the pre-jump-throw control in a jump-throw control state;

a first control module 630, configured to control, in response to a trigger operation of the jump-throw control, the virtual object to be in a pre-throw state; and

a second control module 640, configured to control, based on at least one of the jump-throw control or a preset control, the virtual object to execute a jump-throw operation, the jump-throw operation being that the virtual object in the pre-throw state throws the virtual throwable item, and the preset control being located in the first game interface.

In a possible implementation, the pre-jump-throw control includes a joystick control, the jump-throw control includes a first jump-throw control, and the second display module 620 is configured to display, in response to a trigger operation of the joystick control in a jump-throw control state in a first direction, a first jump-throw control in the first direction of the joystick control in the first game interface, where the first jump-throw control is configured to control a virtual object to sprint and jump.

In a possible implementation, the pre-jump-throw control includes a joystick control, the jump-throw control includes a second jump-throw control, and the second display module 620 is configured to display, in response to a trigger operation of the joystick control in a jump-throw control state in a first direction, a sprint control in the first direction of the joystick control in the first game interface; and display a second jump-throw control in a second direction of the sprint control in the first game interface in response to a trigger operation of the sprint control, where the sprint control is configured to control a virtual object to sprint, and the second jump-throw control is configured to control the virtual object to jump.

In a possible implementation, the pre-jump-throw control includes a throw control, the jump-throw control includes a first jump-throw control, and the second display module 620 is configured to acquire a trigger location of the throw control in response to a trigger operation of the throw control in a jump-throw control state; and display the first jump-throw control in a preset region that corresponds to the trigger location in the first game interface, where the first jump-throw control is configured to control a virtual object to sprint and jump.

In a possible implementation, the pre-jump-throw control includes a jump control, the jump-throw control includes a third jump-throw control, and the second display module 620 is configured to display, in response to a trigger operation of a jump control in a jump-throw control state, the third jump-throw control in a region around the jump control in a jump-throw control state, where the third jump-throw control is configured to control a virtual object to sprint, and the jump control is configured to control the virtual object to jump.

In a possible implementation, the second control module 640 is configured to control, based on the jump-throw control, the virtual object to execute the jump-throw operation, when the control state of the jump-throw control changes and the control state of the preset control does not change; or, controlling, based on the preset control, the virtual object to execute the jump-throw operation, when both the control state of the jump-throw control and the control state of the preset control change; or, controlling the virtual object to execute the jump-throw operation, when the control state of the jump-throw control does not change and the control state of the preset control changes.

In a possible implementation, the second control module 640 is configured to acquire location information and jump-throw parameters when the control state of the jump-throw control or the preset control changes, the location information including at least one of a location of a virtual object or a location of a virtual throwable item; display a predicted trajectory of the virtual throwable item, the predicted trajectory being obtained based on the location information and the jump-throw parameters, and the predicted trajectory of the virtual throwable item being a curve from a jump-throw start point of the virtual throwable item to a jump-throw end point of the virtual throwable item; and control the virtual object to execute a jump-throw operation, in the process that the virtual object executes the jump-throw operation, the virtual throwable item moving based on the predicted trajectory of the virtual throwable item.

In a possible implementation, the second control module 640 is further configured to determine the jump-throw start point of the virtual throwable item based on the location information; and generate the predicted trajectory of the virtual throwable item based on the jump-throw start point and jump-throw parameter of the virtual throwable item.

In a possible implementation, the virtual object in a sprint-jump state does periodic sprint-jump motion in a virtual environment; one cycle is from takeoff to touchdown of the virtual object; the location information includes a location of the virtual object; and the second control module 640 is further configured to determine a reference state of the virtual object based on the location of the virtual object, the reference state including a jump-throw initial state and a jump-throw intermediate state; acquire a location of a first throw point when the virtual object is in the jump-throw initial state, and determine a jump-throw start point of a virtual throwable item based on the location of the first throw point, the first throw point being the location of a highest point to which the virtual object jumps in a current cycle; acquire a location of a second throw point when the virtual object is in the jump-throw intermediate state, and determine a jump-throw start point of the virtual throwable item based on the location of the second throw point, the second throw point being the location of a highest point to which the virtual object jumps in a next cycle of the current cycle; and generate a predicted trajectory of the virtual throwable item based on the jump-throw start point and jump-throw parameter of the virtual throwable item.

In a possible implementation, the location information includes a location of a virtual object; the predicted trajectory of the virtual throwable item includes a first predicted trajectory and a second predicted trajectory; and the second control module 640 is further configured to determine, when the jump-throw parameter includes a first throw parameter, a jump-throw start point of the virtual throwable item based on the location of the virtual object and the first throw parameter, and determine a first predicted trajectory based on the jump-throw start point and first throw parameter of the virtual throwable item; determine, when the jump-throw parameter includes a second throw parameter, a jump-throw start point of the virtual throwable item based on the location of the virtual object and the second throw parameter, and determine a second predicted trajectory based on the jump-throw start point and second throw parameter of the virtual throwable item, in the first throw parameter and the second throw parameter, at least one of a relative location of the virtual throwable item and the virtual object, an angle at which the virtual object throws the virtual throwable item, or an initial speed at which the virtual object throws the virtual throwable item being different.

In a possible implementation, the first display module 610 is further configured to display the second game interface, the second game interface including a virtual object and a pre-jump-throw control in a non-jump-throw control state, and the pre-jump-throw control in a non-jump-throw control state being configured to control the virtual object to execute a specified operation; convert, in response to a use operation of a virtual throwable item, the pre-jump-throw control in a non-jump-throw control state into a pre-jump-throw control in a jump-throw control state; and generate the first game interface based on the virtual object and the pre-jump-throw control in a jump-throw control state.

In a possible implementation, the second control module 640 is further configured to control the virtual object to restore an initial state, the initial state being a state of the virtual object before the use operation of the virtual throwable item in the second game interface.

In this disclosure, a jump-throw control is displayed in a first game interface by a trigger operation of a pre-jump-throw control; a virtual object is controlled using one control (a jump-throw control or a preset control) or two controls (the jump-throw control and the preset control) in the first game interface to execute a jump-throw operation, such that a distance of the virtual throwable item thrown by the virtual object in a virtual environment is increased, thereby lowering the difficulty in implementing the jump-throw operation, and thus allowing the jump-throw operation simple and easy, such that a player can successfully implement the jump-throw operation without multiple attempts, thereby greatly reducing the error rate of the operation, and effectively improving the human-computer interaction efficiency, such that more players can use the jump-throw operation during a game, thereby improving the diversity and competitiveness of game operations to some extent, and thus improving game experience of the players.

When the apparatus provided above implements the functions of the apparatus, only division into the foregoing function modules is used as an example for description. In the practical application, the functions may be allocated to and completed by different function modules according to requirements. That is, an internal structure of the device is divided into different function modules, to complete all or some of the functions described above. In addition, the apparatus and method aspects provided in the foregoing aspects belong to the same conception. For the specific implementation process, reference can be made to the method aspects, which will not be repeated here.

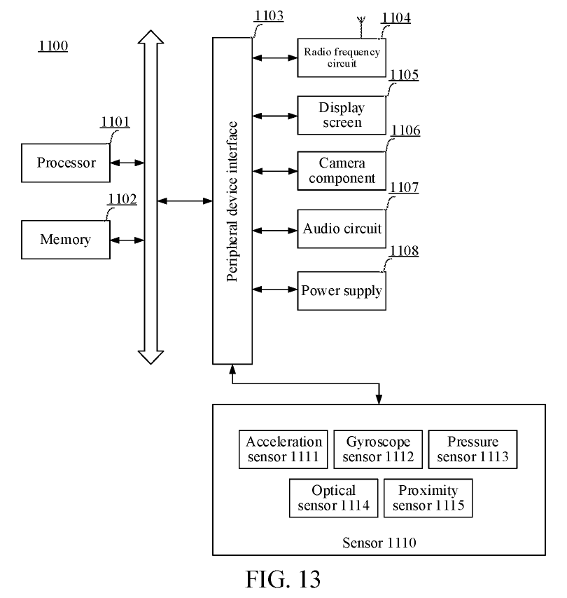

FIG. 13 is a structural block diagram of a terminal device 1100 according to an aspect of this disclosure. The terminal device 1100 may be any electronic device product that perform human-computer interaction with a user in one or more manners such as a keyboard, a touchpad, a remote controller, voice interaction, or a handwriting device. For example, a personal computer (PC), a cell phone, a smartphone, a personal digital assistant (PDA), a wearable device, a pocket PC (PPC), a tablet computer, a smart in-vehicle infotainment system, a smart television, or a smart speaker, a smart watch and the like.

The terminal device 1100 includes a processor 1101 and a memory 1102.

The processor 1101 may include one or more processing cores, for example, a 4-core processor or an 8-core processor. The processor 1101 may be implemented in at least one hardware form of digital signal processing (DSP), a field-programmable gate array (FPGA), and a programmable logic array (PLA). The processor 1101 may also include a main processor and a coprocessor. The main processor is a processor configured to process data in an awake state, and is also referred to as a central processing unit (CPU). The coprocessor is a low power consumption processor configured to process the data in a standby state. In some aspects, the processor 1101 may be integrated with a graphics processing unit (GPU). The GPU is configured to render and draw content that requires to be displayed in a display screen. In some aspects, the processor 1101 may also include an artificial intelligence (AI) processor. The AI processor is configured to process computing operations related to machine learning.

The memory 1102 may include one or more computer-readable storage media. The computer-readable storage medium may be non-transient. The memory 1102 may further include a high-speed random access memory and a nonvolatile memory, for example, one or more disk storage devices or flash storage devices. In some aspects, a non-transient computer-readable storage medium in the memory 1102 is configured to store at least one instruction, and the at least one instruction is executed by the processor 1101 to implement the virtual object control method provided in a method aspect of this disclosure.

In some aspects, the terminal device 1100 further includes: a peripheral device interface 1103 and at least one peripheral device. The processor 1101, the memory 1102, and the peripheral device interface 1103 may be connected via a bus or a signal cable. Each peripheral device may be connected to the peripheral device interface 1103 via a bus, a signal cable, or a circuit board. For example, the peripheral device includes: at least one of a radio frequency circuit 1104, a display screen 1105, a camera component 1106, an audio circuit 1107, and a power supply 1108.

The peripheral device interface 1103 may be configured to connect the at least one peripheral device related to input/output (I/O) to the processor 1101 (an example of processing circuitry) and the memory 1102 (an example of a non-transitory computer-readable storage medium). In some aspects, the processor 1101, the memory 1102 and the peripheral device interface 1103 are integrated on the same chip or circuit board. In some other aspects, any one or two of the processor 1101, the memory 1102, and the peripheral device interface 1103 can be implemented on a single chip or circuit board, which will not be limited in this aspect.

The radio frequency circuit 1104 is configured to receive and transmit an RF signal, which is also referred to as an electromagnetic signal. The radio frequency circuit 1104 communicates with a communication network and other communication devices by the electromagnetic signal. The radio frequency circuit 1104 converts an electrical signal into an electromagnetic signal for transmission, or converts a received electromagnetic signal into an electrical signal. In one aspect, the RF circuit 1104 includes: an antenna system, an RF transceiver, one or more amplifiers, a tuner, an oscillator, a digital signal processor, a codec chip set, a subscriber identity module card, and the like. The radio frequency circuit 1104 may communicate with other terminal devices through at least one wireless communication protocol. The wireless communication protocol includes, but is not limited to, World Wide Web, Metropolitan Area Network, Intranet, all generations of mobile communication networks (2G, 3G, 4G, and 5G), wireless local area networks and/or Wi-Fi networks. In some aspects, the radio frequency circuit 1104 may further include a circuit related to near field communication (NFC), which will not be limited in this disclosure.

The display screen 1105 is configured to display a user interface (UI). The UI may include graphics, texts, icons, videos, and any combination thereof. When the display screen 1105 is a touch display screen, the display screen 1105 also has the capability of collecting a touch signal on or above the surface of the display screen 1105. The touch signal can be inputted to the processor 1101 as a control signal for processing. In this case, the display screen 1105 may be further configured to provide a virtual button and/or a virtual keyboard, which are/is also referred to as a soft button and/or a soft keyboard. In some aspects, there may be one display screen 1105, which is arranged on a front panel of the terminal device 1100. In some other aspects, there may be at least two display screens 1105, which are arranged on different surfaces of the terminal device 1100, respectively or designed in a foldable shape. In still some other aspects, the display screen 1105 may be a flexible display screen, which is arranged on a curved surface or a folded surface of the terminal device 1100. Even, the display screen 1105 may be further configured as a non-rectangular irregular pattern. For example, the display screen is a special-shaped screen. The display screen 1105 can be fabricated from materials such as a liquid crystal display (LCD) or an organic light-emitting diode (OLED).

The camera component 1106 is configured to collect images or videos. In one aspect, the camera component 1106 includes a front-facing camera and a rear-facing camera. The front-facing camera is arranged on the front panel of the terminal device 1100, and the rear-facing camera is arranged on the back surface of the terminal device 1100. In some aspects, there are at least two rear-facing cameras, which are each any of a main camera, a depth-of-field camera, a wide-angle camera, and a telephoto camera, to achieve background blur through fusion of the main camera and the depth-of-field camera, panoramic photographing and virtual reality (VR) photographing through fusion of the main camera and the wide-angle camera, or other fusion photographing functions. In some aspects, the camera component 1106 may further include a flash. The flash may be a single-color temperature flash, or may be a double-color temperature flash. The double-color temperature flash refers to a combination of a warm light flash and a cold light flash, and may be configured for light compensation under different color temperatures.

The audio circuit 1107 may include a microphone and a loudspeaker. The microphone is configured to collect sound waves of a user and an environment, and convert the sound waves into an electrical signal and input the electrical signal to the processor 1101 for processing, or input the electrical signal to the radio frequency circuit 1104 to implement voice communication. For the purpose of stereo acquisition or noise reduction, there may be a plurality of microphones, provided at different portions of the terminal device 1100. The microphone may alternatively be an array microphone or an omni-directional capture microphone. The loudspeaker is configured to convert an electrical signal from the processor 1101 or the radio frequency circuit 1104 into sound waves. The loudspeaker may be a conventional film loudspeaker, or may be a piezoelectric ceramic loudspeaker. When the loudspeaker is the piezoelectric ceramic loudspeaker, the loudspeaker not only can convert an electrical signal into sound waves audible to human beings, but also can convert an electrical signal into sound waves inaudible to human beings, for ranging and other purposes. In some aspects, the audio circuit 1107 may further include an earphone jack.

The power supply 1108 is configured to supply power to each component in the terminal device 1100. The power supply 1108 may be an alternating current, a direct current, a primary battery, or a rechargeable battery. When the power supply 1108 includes the rechargeable battery, the rechargeable battery may be a wired rechargeable battery or a wireless rechargeable battery. The wired rechargeable battery is a battery charged through a wired circuit, and the wireless rechargeable battery is a battery charged through a wireless coil. The rechargeable battery may be further configured to support a fast charging technology.

In some aspects, the terminal device 1100 further includes one or more sensors 1110. The one or more sensors 1110 include but are not limited to an acceleration sensor 1111, a gyroscope sensor 1112, a pressure sensor 1113, an optical sensor 1114, and a proximity sensor 1115.

The acceleration sensor 1111 may detect magnitudes of accelerations on three coordinate axes of a coordinate system established with the terminal device 1100. For example, the acceleration sensor 1111 may be configured to detect components of gravity acceleration on the three coordinate axes. The processor 1101 can control, according to a gravity acceleration signal collected by the acceleration sensor 1111, the display screen 1105 to display the user interface in a landscape view or a portrait view. The acceleration sensor 1111 may be further configured to collect motion data of a game or a user.

The gyroscope sensor 1112 may detect a body direction and a rotation angle of the terminal device 1100. The gyroscope sensor 1112 may cooperate with the acceleration sensor 1111 to acquire a 3D action by the user on the terminal device 1100. The processor 1101 may implement the following functions according to the data collected by the gyroscope sensor 1112: motion sensing (such as changing the UI according to a tilt operation of the user), image stabilization during photography, game control, and inertial navigation.

The pressure sensor 1113 may be provided at a side frame of the terminal device 1100 and/or a lower layer of the display screen 1105. When the pressure sensor 1113 is provided at the side frame of the terminal device 1100, a holding signal of the user on the terminal device 1100 may be detected. The processor 1101 performs left and right hand recognition or a quick operation according to the holding signal acquired by the pressure sensor 1113. When the pressure sensor 1113 is arranged at the lower layer of the display screen 1105, the processor 1101 controls operable controls in the UI according to the user's pressure operation on the display screen 1105. The operable controls include at least one of a button control, a scroll-bar control, an icon control, and a menu control.

The optical sensor 1114 is configured to collect ambient light intensity. In an aspect, the processor 1101 can control the display brightness of the display screen 1105 according to the ambient light intensity collected by the optical sensor 1114. For example, when the ambient light intensity is relatively high, the display brightness of the display screen 1105 is increased. When the ambient light intensity is relatively low, the display brightness of the display screen 1105 is decreased. In another aspect, the processor 1101 can also dynamically adjust photographing parameters of the camera component 1106 according to the ambient light intensity collected by the optical sensor 1114.

The proximity sensor 1115, also referred to as a distance sensor, is provided on the front panel of the terminal device 1100. The proximity sensor 1115 is configured to acquire a distance between the user and a front surface of the terminal device 1100. In an aspect, when the proximity sensor 1115 detects that the distance between the user and the front surface of the terminal device 1100 gradually becomes smaller, the display screen 1105 is controlled by the processor 1101 to switch from a screen-on state to a screen-off state. When the proximity sensor 1115 detects that the distance between the user and the front surface of the terminal device 1100 gradually becomes larger, the display screen 1105 is controlled by the processor 1101 to switch from the screen-off state to the screen-on state.

It is noted that the structure shown in FIG. 13 constitutes no limitation on the terminal device 1100, and the terminal device may include more or fewer components than those shown in the figure, or certain components may be combined, or a different component arrangement can be used.

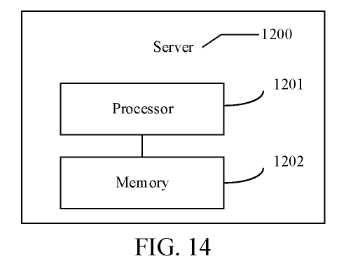

FIG. 14 is a schematic structural diagram of a server according to an aspect of this disclosure. The server 1200 may vary greatly due to different configurations or performance, and may include one or more processors 1201 and one or more memories 1202, where the one or more memories 1202 have at least one program code stored therein, and the at least one program code is loaded and executed by the one or more processors 1201 to implement the virtual object control method provided in the foregoing method aspects. The server 1200 may also have components such as a wired or wireless network interface, a keyboard, and an I/O interface for inputting and outputting. The server 1200 may also include other components configured to implement device functions, which will not be repeated here.

In an aspect, a computer-readable storage medium, such as a non-transitory computer-readable storage medium, is further provided, where the computer-readable storage medium has at least one program code stored therein, and the at least one program code is loaded and executed by a processor, to enable a computer to implement any one of the foregoing the virtual object control methods.

In one aspect, the above-mentioned computer-readable storage medium may be a read-only memory (ROM), a random access memory (RAM), a compact disc read-only memory (CD-ROM), a magnetic tape, a floppy disk, an optical data storage device, or the like.

In an aspect, a computer program or a computer program product is further provided, the computer program or the computer program product having at least one computer instruction stored therein, and the at least one computer instruction being loaded and executed by a processor to enable a computer to implement any one of the foregoing the virtual object control methods.

One or more modules, submodules, and/or units of the apparatus can be implemented by processing circuitry, software, or a combination thereof, for example. The term module (and other similar terms such as unit, submodule, etc.) in this disclosure may refer to a software module, a hardware module, or a combination thereof. A software module (e.g., computer program) may be developed using a computer programming language and stored in memory or non-transitory computer-readable medium. The software module stored in the memory or medium is executable by a processor to thereby cause the processor to perform the operations of the module. A hardware module may be implemented using processing circuitry, including at least one processor and/or memory. Each hardware module can be implemented using one or more processors (or processors and memory). Likewise, a processor (or processors and memory) can be used to implement one or more hardware modules. Moreover, each module can be part of an overall module that includes the functionalities of the module. Modules can be combined, integrated, separated, and/or duplicated to support various applications. Also, a function being performed at a particular module can be performed at one or more other modules and/or by one or more other devices instead of or in addition to the function performed at the particular module. Further, modules can be implemented across multiple devices and/or other components local or remote to one another. Additionally, modules can be moved from one device and added to another device, and/or can be included in both devices.

The use of “at least one of” or “one of” in the disclosure is intended to include any one or a combination of the recited elements. For example, references to at least one of A, B, or C; at least one of A, B, and C; at least one of A, B, and/or C; and at least one of A to C are intended to include only A, only B, only C or any combination thereof. References to one of A or B and one of A and B are intended to include A or B or (A and B). The use of “one of” does not preclude any combination of the recited elements when applicable, such as when the elements are not mutually exclusive.

"A plurality of" mentioned herein refers to two or more. "And/or" describes an association relationship for describing associated objects and represents that three relationships may exist. For example, A and/or B may represent the following three cases: only A exists, both A and B exist, and only B exists. The character "/" indicates an "or" relationship between the associated objects.

The foregoing descriptions are merely example aspects of this disclosure, and are not intended to limit this disclosure. Any modification, equivalent replacement, or improvement made within the principle of this disclosure shall fall within the scope of this disclosure.

What is claimed is:

1. A virtual object control method, comprising:
outputting for display a virtual object in a virtual scene and a game control interface that includes a pre-jump-throw control element in a jump-throw control state, the virtual object having a virtual throwable item;
determining a trigger operation is performed on the pre-jump-throw control element;
based on the trigger operation performed on the pre-jump-throw control element in the jump-throw control state, outputting for display a jump-throw control element in the game control interface;
determining a trigger operation is performed on the jump-throw control element;
based on the trigger operation performed on the jump-throw control element, controlling the virtual object to be in a pre-throw state; and
based on at least one of the jump-throw control element or a preset control element in the game control interface, controlling the virtual object to execute a jump-throw operation, the jump-throw operation including the virtual object in the pre-throw state throwing the virtual throwable item.

2. The method according to claim 1, wherein
the pre-jump-throw control element includes a joystick control element; and
the outputting for display the jump-throw control element includes outputting for display the jump-throw control element in a first direction of the joystick control element based on a trigger operation performed on the joystick control element in the first direction, the virtual object being controlled to sprint, jump in the pre-throw state when the trigger operation is performed on the jump-throw control element.

3. The method according to claim 1, wherein
the pre-jump-throw control element includes a joystick control element; and
the outputting for display the jump-throw control element comprises:
outputting for display a sprint control element in a first direction of the joystick control element based on a trigger operation performed on the joystick control element in the first direction; and
outputting for display the jump-throw control element in a second direction of the sprint control element based on a trigger operation performed on the sprint control element, the virtual object being controlled to sprint when the trigger operation is performed on the sprint control element, and the virtual object being controlled to jump in the pre-throw state when the trigger operation is performed on the jump-throw control element.

4. The method according to claim 1, wherein
the pre-jump-throw control element includes a throw control element; and
the method further includes obtaining a trigger position of a trigger operation performed on the throw control element in the jump-throw control state; and
the outputting for display the jump-throw control element includes outputting for display the jump-throw control element in a preset region corresponding to the trigger position, the virtual object being controlled to sprint and jump in the pre-throw state when the trigger operation is performed on the jump-throw control element.

5. The method according to claim 1, wherein
the pre-jump-throw control element includes a jump control element; and
the outputting for display the jump-throw control element includes outputting for display the jump-throw control element in a region surrounding the jump control element based on a trigger operation performed on the jump control element in the jump-throw control state, the virtual object being controlled to sprint when the trigger operation is performed on the jump-throw control element, and the virtual object being controlled to jump when the trigger operation is performed on the jump control element.

6. The method according to claim 1, wherein the controlling the virtual object to execute the jump-throw operation comprises:
controlling the virtual object to execute the jump-throw operation based on the jump-throw control element, when a control state of the jump-throw control element changes and a control state of the preset control element does not change;
controlling the virtual object to execute the jump-throw operation based on the preset control element when the control state of the jump-throw control element and the control state of the preset control element change; and
controlling the virtual object to execute the jump-throw operation based on the jump-throw control element and the preset control element when the control state of the jump-throw control element does not change and the control state of the preset control element changes.

7. The method according to claim 1, further comprising:
outputting for display a predicted trajectory of the virtual throwable item, the predicted trajectory being determined based on location information and jump-throw parameters obtained when a control state of the jump-throw control element or the preset control element changes, the location information including at least one of a location of the virtual object or a position of the virtual throwable item; and
controlling the virtual object to execute the jump-throw operation such that the virtual throwable item moves along the predicted trajectory.

8. The method according to claim 7, further comprising:
determining a jump-throw start point of the virtual throwable item based on the location information; and
generating the predicted trajectory of the virtual throwable item based on the jump-throw start point and the jump-throw parameters.

9. The method according to claim 7, wherein
the virtual object performs a periodic sprint-jump motion in a virtual environment, one cycle being from takeoff to landing of the virtual object;
the location information includes the position of the virtual object, and
the method further comprises:
determining a reference state of the virtual object based on the position of the virtual object, the reference state including a jump-throw initial state and a jump-throw intermediate state;
when the virtual object is in the jump-throw initial state,
obtaining a first throw point indicating a highest position reached in a current cycle, and
determining a jump-throw start point based on the first throw point;
when the virtual object is in the jump-throw intermediate state,
obtaining a second throw point indicating a highest position reached in a next cycle of the current cycle, and
determining the jump-throw start point based on the second throw point; and
generating the predicted trajectory of the virtual throwable item based on the jump-throw start point and the jump-throw parameters.

10. The method according to claim 7, wherein
the location information includes the position of the virtual object;
the method further comprises:
when the jump-throw parameters include a first throw parameter,
determining a jump-throw start point of the virtual throwable item based on the position of the virtual object and the first throw parameter, and
determining the predicted trajectory based on the jump-throw start point and the first throw parameter; and
when the jump-throw parameters include a second throw parameter,
determining the jump-throw start point of the virtual throwable item based on the position of the virtual object and the second throw parameter, and
determining the predicted trajectory based on the jump-throw start point and the second throw parameter,
wherein the first throw parameter and the second throw parameter are different in at least one of a relative location between the virtual throwable item and the virtual object, a throwing angle, or an initial speed.

11. The method according to claim 1, further comprising:
outputting for display the pre-jump-throw control element in a non-jump-throw control state, the pre-jump-throw control element in the non-jump-throw control state being used to control the virtual object to execute a specified operation; and
based on a use operation performed on the virtual throwable item, changing the pre-jump-throw control element in the non-jump-throw control state to the pre-jump-throw control element in the jump-throw control state.

12. A virtual object control apparatus, comprising:
processing circuitry configured to:
output for display a virtual object in a virtual scene and a game control interface that includes a pre-jump-throw control element in a jump-throw control state, the virtual object having a virtual throwable item;
determine a trigger operation is performed on the pre-jump-throw control element;
based on the trigger operation performed on the pre-jump-throw control element in the jump-throw control state, output for display a jump-throw control element in the game control interface;
determine a trigger operation is performed on the jump-throw control element;
based on the trigger operation performed on the jump-throw control element, control the virtual object to be in a pre-throw state; and
based on at least one of the jump-throw control element or a preset control element in the game control interface, control the virtual object to execute a jump-throw operation, the jump-throw operation including the virtual object in the pre-throw state throwing the virtual throwable item.

13. The virtual object control apparatus according to claim 12, wherein
the pre-jump-throw control element includes a joystick control element; and
the processing circuitry is configured to:
output for display the jump-throw control element in a first direction of the joystick control element based on a trigger operation performed on the joystick control element in the first direction, the virtual object being controlled to sprint and jump in the pre-throw state when the trigger operation is performed on the jump-throw control element.

14. The virtual object control apparatus according to claim 12, wherein
the pre-jump-throw control element includes a joystick control element; and
the processing circuitry is configured to:
output for display a sprint control element in a first direction of the joystick control element based on a trigger operation performed on the joystick control element in the first direction; and
output for display the jump-throw control element in a second direction of the sprint control element based on a trigger operation performed on the sprint control element, the virtual object being controlled to sprint when the trigger operation is performed on the sprint control element, and the virtual object being controlled to jump in the pre-throw state when the trigger operation is performed on the jump-throw control element.

15. The virtual object control apparatus according to claim 12, wherein
the pre-jump-throw control element includes a throw control element; and
the processing circuitry is configured to:
obtain a trigger position of a trigger operation performed on the throw control element in the jump-throw control state; and
output for display the jump-throw control element in a preset region corresponding to the trigger position, the virtual object being controlled to sprint and jump in the pre-throw state when the trigger operation is performed on the jump-throw control element.

16. The virtual object control apparatus according to claim 12, wherein
the pre-jump-throw control element includes a jump control element; and
the processing circuitry is configured to:
output for display the jump-throw control element in a region surrounding the jump control element based on a trigger operation performed on the jump control element in the jump-throw control state, the virtual object being controlled to sprint when the trigger operation is performed on the jump-throw control element, and the virtual object being controlled to jump when the trigger operation is performed on the jump control element.

17. The virtual object control apparatus according to claim 12, wherein the processing circuitry is configured to:
control the virtual object to execute the jump-throw operation based on the jump-throw control element, when a control state of the jump-throw control element changes and a control state of the preset control element does not change;
control the virtual object to execute the jump-throw operation based on the preset control element when the control state of the jump-throw control element and the control state of the preset control element change; and
control the virtual object to execute the jump-throw operation based on the jump-throw control element and the preset control element when the control state of the jump-throw control element does not change and the control state of the preset control element changes.

18. The virtual object control apparatus according to claim 12, wherein the processing circuitry is configured to:
output for display a predicted trajectory of the virtual throwable item, the predicted trajectory being determined based on location information and jump-throw parameters obtained when a control state of the jump-throw control element or the preset control element changes, the location information including at least one of a location of the virtual object or a position of the virtual throwable item; and
control the virtual object to execute the jump-throw operation such that the virtual throwable item moves along the predicted trajectory.

19. The virtual object control apparatus according to claim 18, wherein the processing circuitry is configured to:
determine a jump-throw start point of the virtual throwable item based on the location information; and
generate the predicted trajectory of the virtual throwable item based on the jump-throw start point and the jump-throw parameters.

20. A non-transitory computer-readable storage medium storing instructions which, when executed by a processor, cause the processor to perform:
outputting for display a virtual object in a virtual scene and a game control interface that includes a pre-jump-throw control element in a jump-throw control state, the virtual object having a virtual throwable item;
determining a trigger operation is performed on the pre-jump-throw control element;
based on the trigger operation performed on the pre-jump-throw control element in the jump-throw control state, outputting for display a jump-throw control element in the game control interface;
determining a trigger operation is performed on the jump-throw control element;
based on the trigger operation performed on the jump-throw control element, controlling the virtual object to be in a pre-throw state; and
based on at least one of the jump-throw control element or a preset control element in the game control interface, controlling the virtual object to execute a jump-throw operation, the jump-throw operation including the virtual object in the pre-throw state throwing the virtual throwable item.
